(19) United States
(12) Patent Application Publication
(10) Pub. No.: US 2014/0080660 A1
(43) Pub. Date: Mar. 20, 2014

(54) USING AN INTEGRATED STARTER/GENERATOR TO REPLICATE IMPELLER CLUTCH FUNCTIONALITY

(71) Applicants: Yanchai Zhang, Dunlap, IL (US); Benjamin A. Treichel, Peoria, IL (US); Evan Earl Jacobson, Edwards, IL (US); Koti Ratnam Padarthy, Edwards, IL (US)

(72) Inventors: Yanchai Zhang, Dunlap, IL (US); Benjamin A. Treichel, Peoria, IL (US); Evan Earl Jacobson, Edwards, IL (US); Koti Ratnam Padarthy, Edwards, IL (US)

(73) Assignee: CATERPILLAR, INC., Peoria, IL (US)

(21) Appl. No.: 13/618,017

(22) Filed: Sep. 14, 2012

(51) Int. Cl. B60W 20/00; B60W 10/08; B60W 10/06

(52) U.S. Cl. CPC B60W 20/00; B60W 10/06; B60W 10/08; Y10S 903/93
USPC 477/3; 180/65.28; 180/65.285; 903/930

(57) ABSTRACT

A method utilizing an integrated starter generator as a hybrid power source to an engine in a movable device is also disclosed. The impeller clutch activation decision may be based on load demand, more specifically, whether load demand for the engine is greater than the power from the engine at the current speed of the engine.

Large equipment has to be able to complete a variety of tasks. The equipment has to be able to execute tasks that require great strength and power while being mobile. A variety of systems are including to execute these tasks, including a primary power source and other systems which may redeploy power from the primary power source, such as hydraulic systems and electrical systems.

Providing additional power to move bigger objects and lift bigger things usually means installing a larger engine with additional power. Additional power has often meant more fuel consumption. While engine efficiency has improved over time, fuel costs are still significant. Every gain in efficiency is meaningful. In addition, the equipment has to be reliable and long lasting, meaning that the pursuit of efficiency cannot overshadow the need for the equipment to be long lasting.

### SUMMARY

A power platform for a motorized work device that includes hybrid power sources is disclosed. The hybrid power system may include a hydraulic power source that provides power and stores power, an electric power source that provides power and stores power and a kinetic power source that provides power and stores power. The power platform may also include an engine, such as an internal combustion engine, including a reduced power than engines for similar sized devices where the hydraulic power source, electric power source and kinetic power source provide additional power to the engine when required. The hydraulic power source, the electric power source and kinetic power source may also store power when excess power is available to be stored. Further, if the engine is under stress, additional power may be provided from at least one of the hydraulic power source, the electric power source and the kinetic power source.

The kinetic power source may include a high speed, low mass flywheel that is in communication with the power source. The hydraulic power source may include an accumulator that is filled if reverse pressure is presented to the hydraulic system along with a hydraulic pump and hydraulic supply lines that communicate with the hydraulic pump, the accumulator and the hydraulic supply lines. The electric power source may include an electricity storing device such as one or more batteries or capacitors that store electricity when reverse pressure is provided to a generating device along with an integrated starter-generator which is in communication with the drivetrain of the device and provides power as a motor when needed.

The system may operating in a variety of modes depending on a variety of factors including the location of the device, the current demands on the device, the start of charge of the hybrid systems and available power from the primary power unit. The decision on the mode to use may be made using a remote or distant computing device physically configured to make the decision. Further, the decision on which hybrid system to use store or provide additional power may be based on a plurality of functions that may vary based on a variety of inputs to the system.

A method utilizing an integrated starter generator as a hybrid power source to an engine in a movable device in place of an impeller clutch is also disclosed. The impeller clutch activation decision may be based on load demand, more specifically, whether load demand for the engine is greater than the power from the engine at the current speed of the engine. One of the hybrid power sources may be used to provide additional torque to the engine, such as the integrated starter/generator.

The method may have many embodiments and at a high level, the method may receive impeller clutch inputs, determine if impeller clutch activation is indicated and if an impeller clutch activation is indicated, using the integrated starter generator as a motor to provide additional torque to an engine crankshaft. In some embodiments, it may be determined if there is sufficient available stored energy to operate the integrated starter generator. If there is not sufficient available stored energy, the integrated starter generator may not be used as motor.

If an impeller clutch activation is indicated and the integrated starter generator is used as a motor to provide additional torque to an engine crankshaft, it may be determined if the load has fallen below the output of the engine. If the load is below the output of the engine, the integrated starter generator may be depowered from the engine crankshaft. If there is not sufficient available stored energy, speed may be added to the engine. If the device is decelerating, the integrated started generator may be engaged to the crankshaft as a generator to reduce crankshaft speed and generate electricity.

### BRIEF DESCRIPTION OF THE DRAWINGS

FIG. 1 is an illustration of a device with hybrid power equipment;

FIG. 2 is an illustration of blocks of parts that may up a hybrid power system;

FIG. 3 is an illustration of an integrated starter/generator power system;

FIG. 4 is an illustration of a hydraulic storage and power supplying system;

FIG. 5 is an illustration of a kinetic storage system;

FIG. 6 is an illustration of the decision on which hybrid system to use;

FIG. 7 is an illustration of a portable computing device communicating to a remote computing device;

FIG. 8 is an illustration of the elements of a portable computing system;

FIG. 9 is an illustration of the elements of server based computing system;

FIG. 10 is an illustration of a system that uses an impeller clutch;

FIG. 11 is an illustration of a system that uses hybrid power in place of an impeller clutch; and

FIG. 12 is an illustration the decisions making inputs and outputs in the hybrid system with the integrated starter generator in impeller clutch replacement mode.

### DESCRIPTION

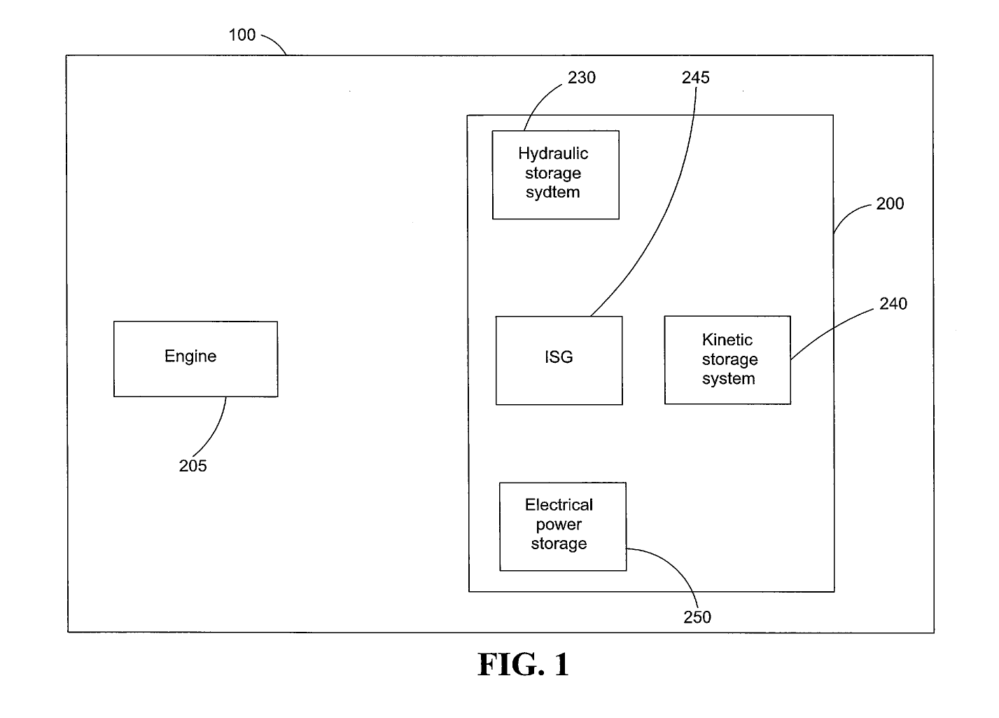

FIG. 1 illustrates one embodiment of a power platform for a motorized work device. The work device may be a variety of devices. Some example work devices may include, but should not be limited to, bulldozers, diggers, earth movers, graders, etc. In general, the work devices have an internal combustion based power source, such as an engine that operated on diesel fuel or gasoline or any other appropriate fuel. Other systems could operate using the power from the power source such as hydraulic systems but the other systems did not store or contribute power back to the power source. In the past, the internal combustion engine had to be sized such that it could provide sufficient power alone to operate the vehicle as it did not have any other power supplying systems to rely upon.

There are a variety of hybrid power source that may assist a main power source, each of which has its own advantages and disadvantages. FIG. 1 may illustrate a variety of hybrid power sources that may be part of a work device. At a high level, the hybrid power sources may store power when excess power is available, such as when a device is traveling downhill, and may supply power when excess power is needed such as lifting a heavy object. At times, the hybrid sources may be the primary source of power. At other times, the hybrid sources may not supply any power to the main source of power. At yet other times, one or more of the hybrid power sources may assist the main power source when excess power is needed. The decision of which hybrid source to use and when may be governed by an algorithm. The result of the hybrid system is that a smaller main power source may be used which may result in a more efficient system.

FIG. 1 is an illustration of a sample work device 100 with hybrid power sources 200. In one embodiment, an internal combustion engine 205 may be the main source of power and may be used along with the hybrid power sources 200. In other embodiments, any of the hybrid sources 200 of power may be the main power source 205 with the other hybrid power sources 200 supplying power on an as needed basis. The main power source 205 may be smaller than a single main power source 205 as the hybrid sources 200 may provide additional power when needed such that the main power source 205 may be smaller, lighter and more efficient than in a device without the hybrid power sources 200.

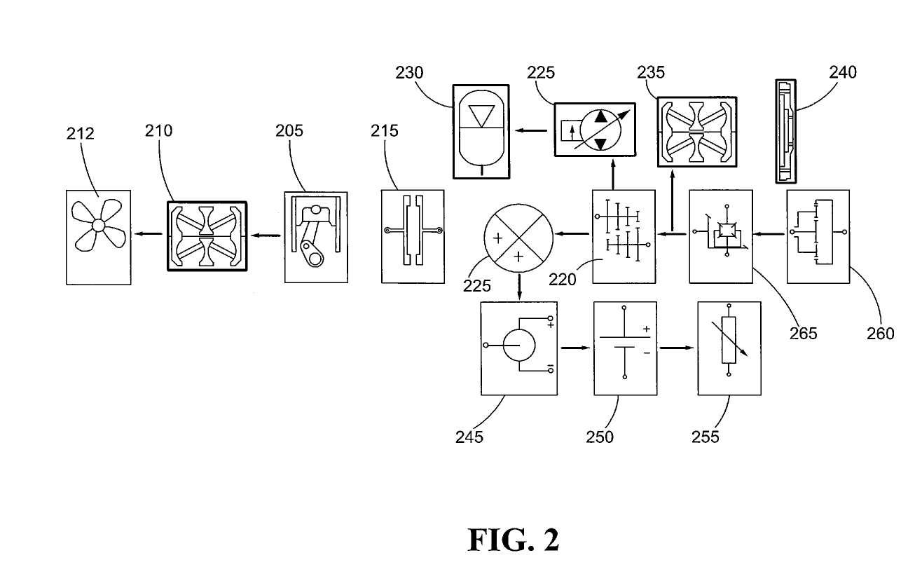

Referring to FIG. 2, possible sources of hybrid power 200 and storage may include a kinetic storage device 240, such as a flywheel 510, a hydraulic storage device 230 such as a large hydraulic accumulator in communication with a hydraulic pump/motor 225 and an integrated starter/generator 245 that may be connected to various electricity storage devices 250 such as batteries or capacitors. Of course, some of the hybrid sources 200 may be omitted and others added. The disclosed combinations and arrangements are not meant to be limiting but only example as there are a variety of ways to uses hybrid power systems 200 with a main power system and all of these various arrangements are possible and contemplated.

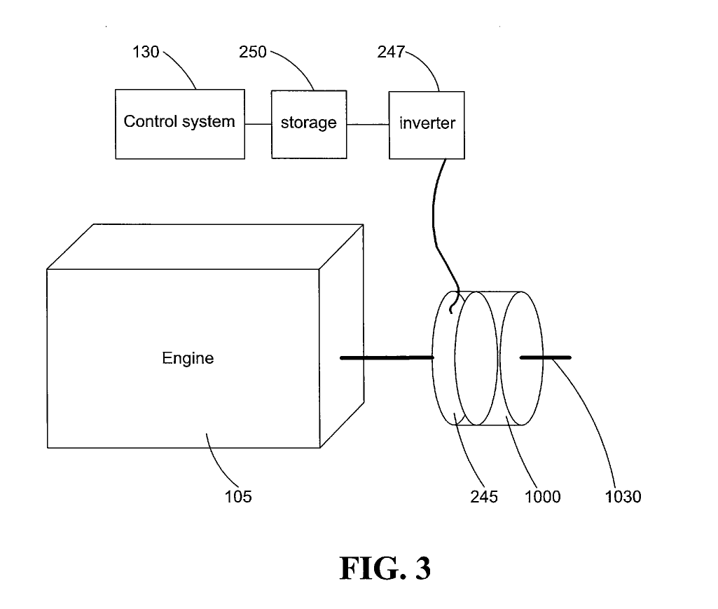

FIG. 3 may illustrate some of the elements of an electrical hybrid system. An integrated starter/generator 245 may be used before or after a transmission to act as an electric generator when excess power is available such as when a device 100 is proceeding downhill or when brakes are being applied. An integrated starter generator 245 may be an electric motor that provides torque to a shaft when electricity is applied to it and provides electricity when the shaft is spun using excess force from the device 100. The generated electricity may be stored in a variety of way, such as in batteries 250 or in capacitors. In addition, in some embodiments, the integrated starter generator 245 may serve to eliminate the need for an impeller clutch as will be explained with reference to FIG. 16. The integrated starter generator 245 may use excess energy to spin the integrated starter/generator which may generator electricity which may pass through an inverter 247 and be stored in storage device 250 such as a battery or capacitor.

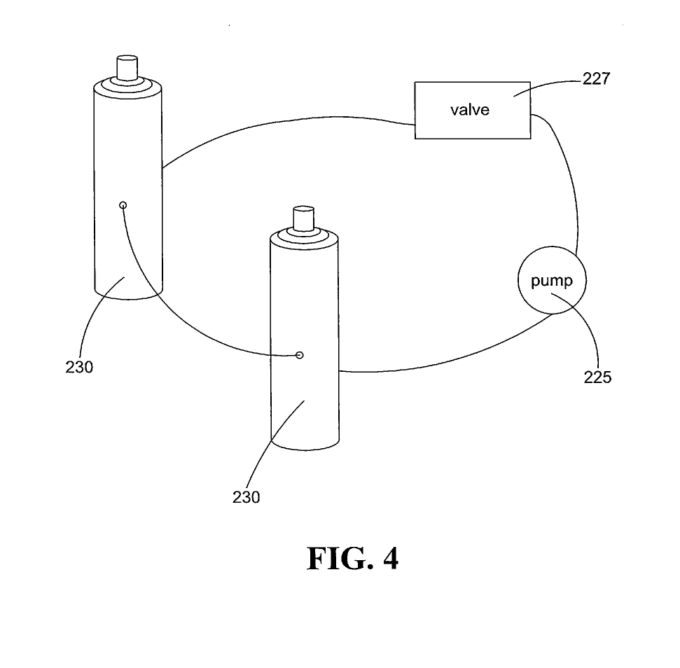

Another form of storing energy and delivering power may be a hydraulic source. FIG. 4 may illustrate one embodiment of a hydraulic power source. The hydraulic power source may include a hydraulic pump/motor 225, a valve 227 and one or more accumulators 230 that store hydraulic fluid under pressure. The hydraulic pump/motor 225 may be driven by the force of the device as is travels downhill, for example, and the pump/motor 225 may force hydraulic fluid into the accumulator 230 where it may rest under pressure until it is needed at which time the pressurized fluid may leave the accumulator 230 and provide power to a hydraulic device. The accumulator 230 may be any type of accumulator 230 that is appropriate for the device. In some embodiments, a larger accumulator 230 such that the accumulator 230 may store more power in the form of hydraulic fluid that is under pressure.

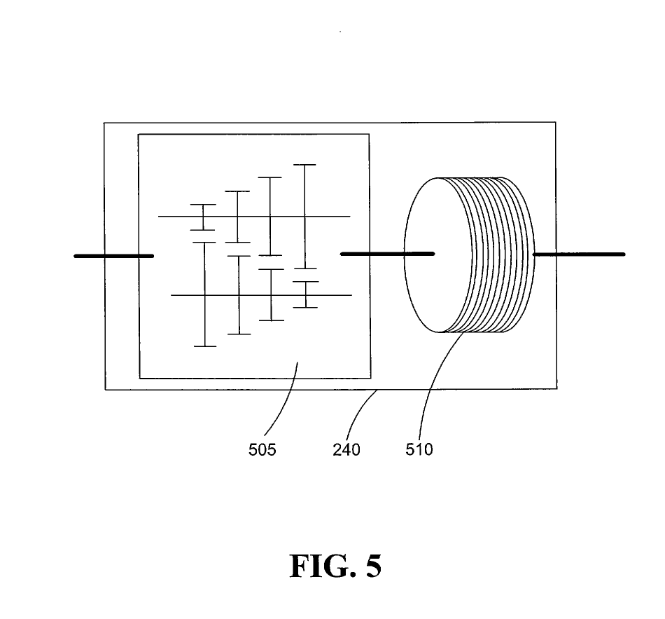

Another hybrid power source 200 may be a kinetic power storage device 240. FIG. 5 may illustrate a sample kinetic power source 240. A kinetic storage device 240 may store energy in a spinning object 500. In some embodiments, the spinning object 500 is a heavy object that once it is spinning is hard to stop as the momentum of the object 500 wants to keep the object spinning. Spinning a heavy object 500 at a high speed may be difficult and controlling heavy objects 500 that spin at high speeds may be a challenge. In other embodiments, the spinning object 500 may be lighter but may spin at a high rate of speed which also creates a significant amount of momentum that wants to keep the object 500 spinning. In this way, the extra weight from the spinning object 500 may be less, but energy still may be stored. FIG. 5 may illustrate a sample kinetic storage device 240 which may have a flywheel 500. The kinetic storage device 240 may also have a transmission 505 which may be used to translate the speed of the flywheel into a usable speed and torque by the system.

Power in the form of stored energy may also be supplied from the kinetic storage device 240 but the kinetic energy stored in the spinning object 500 may be used to supplement the main power source 205 or any other source 200. For example, a flywheel 500 may be the kinetic storage object and may be in communication with the crankshaft of an internal combustion engine 205 or the drivetrain to provide additional power to the main power source 205. Of course, the kinetic storage object 500 may provide power to a generator, for example, which may provide power to the other hybrid power sources 200 which may be stored by the other objects.

A control strategy may be used to determine which hybrid storage system 200 may be available to store excess power and which to the hybrid power systems may be best suited to provide additional power when additional power is needed. The strategy may be found in hardware, software, or in a combination of hardware and software. At a high level, when excess power is available, the various hybrid systems 200 may be scored to determine which may be charged most efficiently in the given situation. Similarly, when power is needed by the primary power source 205, a scoring function may be used to determine which of the various power sources 2000 may be able to provide the needed power in the most efficient fashion. The scoring may vary depending of the type of power to be stored or the type of power needed.

Hybrid Decision Making

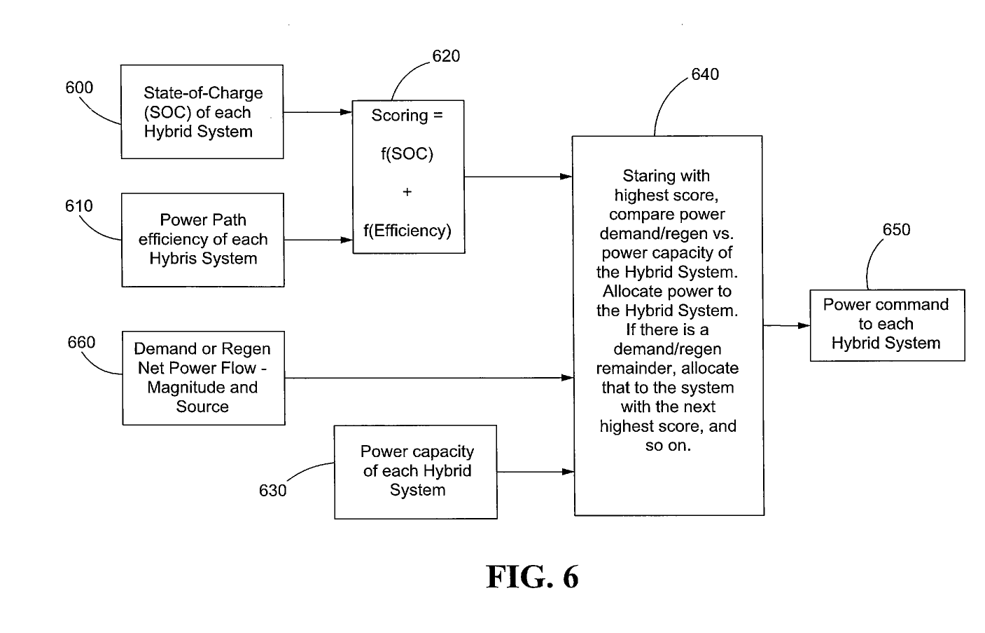

FIG. 6 may illustrate at a high level one possible embodiment of deciding which hybrid power source 200 to use. At block 600, the state of charge of each hybrid system may be determined. For example, the charge in the electric storage device 250 may be determined. In addition, the power path efficiency 610 of each hybrid system may also be determined. For example, a certain integrated starter/generator may be especially useful at providing a quick burst of torque, making them useful when torque is desired. Similarly, certain hydraulic motors may be less efficient at providing torque making them less efficient when torque is desired.

In block 620, the state of charge and the power path efficiency of each hybrid system may be scored. The scoring may involve subjecting the state of charge to a charge function and the power path efficiency to a path function and the results of the function may be totaled. The charge function and path function may vary based on a variety of factors, such as the type of power demanded, the anticipated length of time the power will be demanded, the environmental factors, etc. For example, if the device 100 is working in extreme cold environment, batteries 250 may be more quickly depleted of power and the function may take this issue into account.

At block 630, the power capability of each hybrid system 200 may be evaluated. For example, if excess power is available, it may be stored in one of the hybrid systems 200 if there is sufficient capacity to store the power. If the hybrid system 200 storage is already full, then it may be physically impossible to store more. Similarly, if a power storage device is currently storing little power, the power storage device in question may be the first choice to receive excess power.

At block 640, the scores from block 620 are reviewed. Based on the review, power may be obtained from the hybrid system 200 or may be allocated to be stored by the various hybrid systems 200. In addition, if one hybrid system 200 is “full” or at capacity of stored energy, the excess energy may be supplied to another hybrid storage system 200. Similarly, if energy is needed, the scores from block 620 may be reviewed to determine a hybrid source 200 to be used for excess power. At a high level, whether storing or releasing power, the hybrid system 200 with the highest power score may be selected first. When considering storing power, a high score results from having a low state of charge but high efficiency and when considering releasing power, a high score may result from having a high state of charge and high efficiency.

Computing Elements

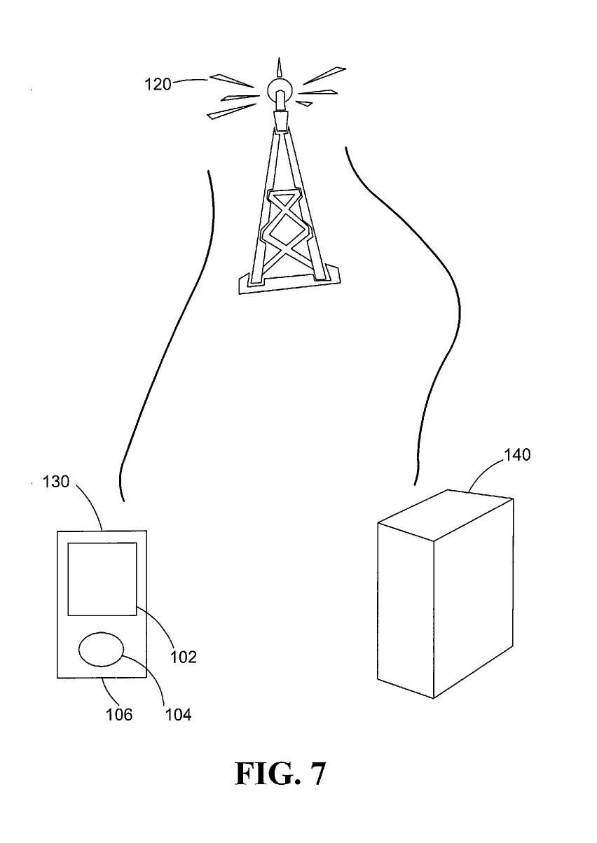

More specifically, FIG. 7 may be a high level illustration of some of the elements a sample computing system that may be physically configured to execute many of the decisions, including the decisions of the hybrid power system. The computing system may be a dedicated computing device 140, a dedicated portable computing device 130, an application on the computing device that physically configures the processor in the computing device 140, an application on the portable computing device that configures the processor in the portable computing device 130 or a combination of all of these elements.

In one embodiment, a portable computing device 130 may be a device that operates using a portable power source such as a dedicated battery or it may use the battery 250 from the device 100. The portable computing device 130 may also have a display 102 which may or may not be a touch sensitive display. More specifically, the display 102 may have a capacitance sensor, for example, that may be used to provide input data to the portable computing device 100. In other embodiments, an input pad 104 such as arrows, scroll wheels, keyboards, etc., may be used to provide inputs to the portable computing device 100. In addition, the portable computing device 100 may have a microphone 106 which may accept and store verbal data.

The portable computing device 130 may be able to communicate with a remote computing device 140. The portable computing device 130 may be able to communicate in a variety of ways. In some embodiments, the communication may be wired such as through an Ethernet cable, a USB cable or RJ6 cable. In other embodiments, the communication may be wireless such as through wifi (802.11 standard), Bluetooth, cellular communication or near field communication devices. The communication may be direct to the computing device 140 or may be through a communication network 120 such as cellular service, through the Internet, through a private network, through Bluetooth, etc.

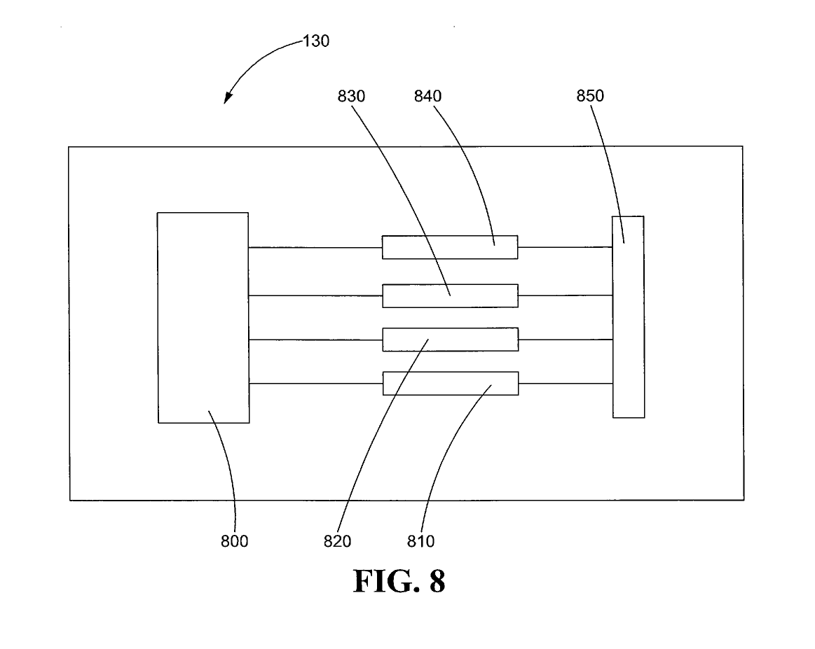

FIG. 8 may be a simplified illustration of the physical elements that make up a portable computing device 130 and that may be physically configured according to be part of the system. The portable computing device may be integrated into the device 100 or may be a separate device that is used in or near the device 100. The portable computing device 130 may have a processor 800 that is physically configured according to computer executable instructions. It may have a portable power supply 810 such as a battery which may be rechargeable. It may also use an additional battery, such as the storage device 250 in the device 130. It may also have a sound and video module 820 which assists in displaying video and sound and may turn off when not in use to conserve power and battery life. The portable computing device 130 may also have volatile memory 830 and non-volatile memory 840. There also may be an input/output bus 850 that shuttles data to and from the various user input devices such as the microphone 106, the inputs, etc. It also may control of communicating with the networks, either through wireless or wired devices. Of course, this is just one embodiment of the portable computing device 130 and the number and types of portable computing devices 130 is limited only by the imagination.

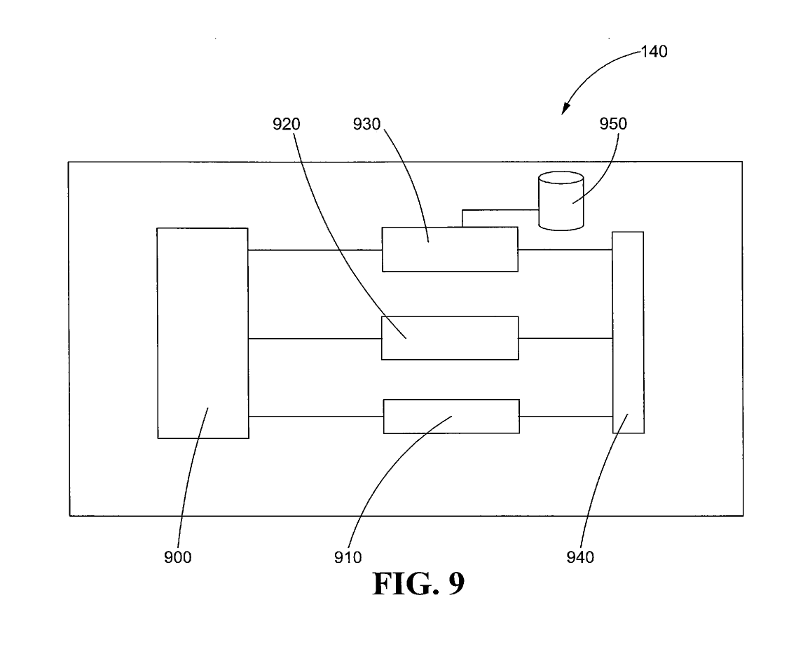

FIG. 9 may be a sample server 140 that is physically configured according to be part of the system. The server 140 may have a processor 900 that is physically configured according to computer executable instructions. It may also have a sound and video module 910 which assists in displaying video and sound and may turn off when not in use to conserve power and battery life. The server 140 may also have volatile memory 920 and non-volatile memory 930. The database 950 may be stored in the memory 920 or 930 or may be separate. The database 950 may also be part of a cloud of computing device 140 and may be stored in a distributed manner across a plurality of computing devices 140. There also may be an input/output bus 940 that shuttles data to and from the various user input devices such as the microphone, the inputs 106, etc. The input/output bus 940 also may control of communicating with the networks, either through wireless or wired devices. Of course, this is just one embodiment of the server 140 and the number and types of portable computing devices 140 is limited only by the imagination.

Integrated Starter/Generator Operation

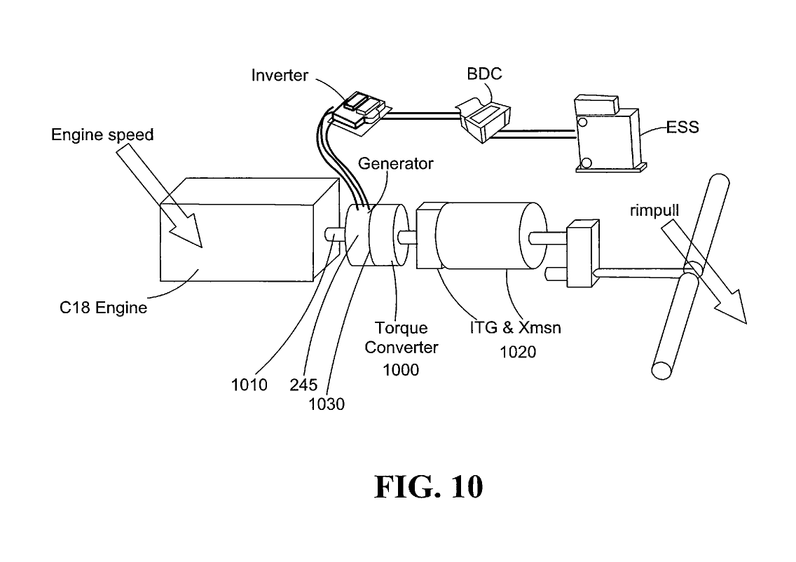

There may also be one or more methods of utilizing an integrated starter generator 245 as a hybrid power source 200 to an engine in a movable device 100. At times, demand on an engine 205 may be great, so great that a normal power source 205 may be overwhelmed and may stall. Referring to FIG. 10, in these instances, a clutch on an impeller 1010 may remove power to the impeller 1010 to provide power to other parts of the movable device 100. As an example, if the movable device 100 is using hydraulic power to lift something especially heavy, it may dangerous if the device requires power and the power cannot be delivered. Thus, the impeller clutch may remove power from the impeller 1010 in a torque convertor 1000 and provide additional power to the hydraulic system. It may be useful to use a hybrid system to provide the needed additional power rather than having to have the weight and complexity of an impeller clutch. FIG. 10 may illustrate a situation where demands on the engine 205 cause unwanted rimpull.

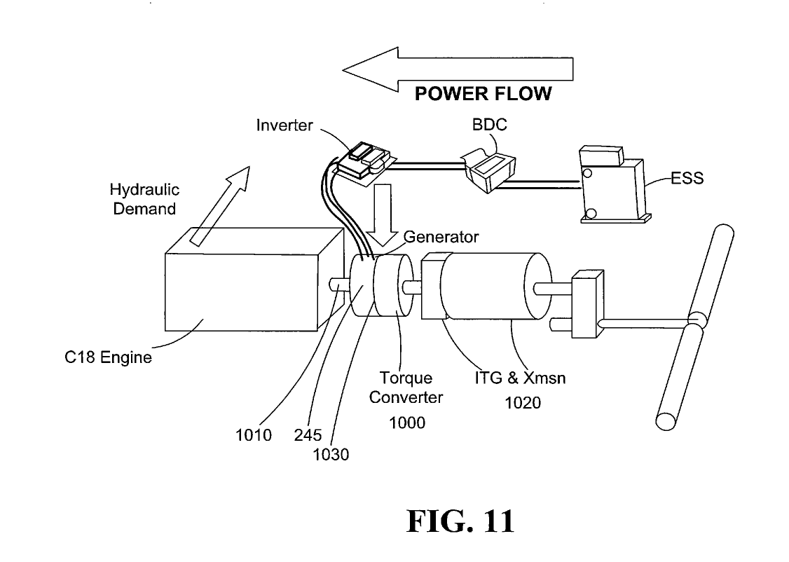

FIG. 11 may be an illustration of a system that uses a hybrid power source 200 to provide the functionality of an impeller clutch while eliminating the impeller clutch. A torque converter 1000 may be able to multiply torque when there is a substantial difference between input and output rotational speed, thus acting like a reduction gear. In a torque convertor 1000, there are at least three rotating elements: an impeller 1010 which is mechanically driven by the main power source 205, the turbine 1020 which drives the load and the stator 1030 which is interposed between the impeller 1010 and the turbine 1020 so that it may alter oil flow returning from the turbine 1020 to the impeller 1010.

An impeller clutch may be an additional part in a torque converter 1000. The clutch may normally be locked where the input speed and the output speed may be the same and may require pressure to start to release the impeller clutch. The impeller of a torque converter 1000 may absorb the power it is designed for, specifically, at a specified engine speed and torque converter turbine speed. It is the torque converter 1000 that allows the engine 205 to idle without stalling. However, if the engine 205 is not able to produce sufficient power to satisfy the torque converters 1000 demands, the engine 205 speed may not be able to accelerate past a certain point. Torque converters 1000 may be selected for large devices 100 such as wheel loaders based upon the maximum amount of power that the drivetrain may be permitted to use to move the machine 100. The torque converter may be sized so that there is power in reserve for the hydraulic implements and other accessories, such as ⅔ of engine 205 power. At certain times, such as lifting a large load which may require significant hydraulic power, an operator may engage the impeller clutch such as stepping on an impeller clutch pedal. The clutch may reduce rimpull at the tires, which may allow the operator to better control the machine 100. In effect, the engine 205 may be increasingly separated from the rear wheels as the clutch is engaged. As a secondary effect, the engine 205 may have more power available for the hydraulic systems and other accessories 212.

The impeller clutch may operate by slipping, which may cause less power to pass through to the drivetrain. However, the impeller clutch may have a speed differential across it. As the torque passed through the clutch may be the same at input and output, the loss in the clutch may be the speed differential multiplied by the torque. The clutch may be effective but creates a loss of power. The loss of power may be viewed as having a smaller, less absorptive torque converter 1000 in the machine when the impeller clutch is used.

In some embodiments, the slippage across the clutch may be captured as stored energy. As an example, the integrated starter/generator 245 may be used to slow the engine 205 when impeller clutch activation is determined to be useful. The integrated starter/generator 245 may spin and generate electricity which may be stored. Similarly, the kinetic power source 240 may be engaged to slow the engine and the power may be stored in the kinetic storage device 510 or the excess power may be used to activate a hydraulic pump 225 which may be used to fill the accumulators 230 for future use. Thus, the slippage may also be applied to a kinetic storage device 510 or the hydraulic power source 200 which may also store the excess energy.

At some times, the impeller 1010 and turbine 1020 may be physically locked together so that there is virtually no slippage and no loss of power and improved efficiency. At other times such as idle or stoppage, the impeller 1010 may be decoupled from the engine during idle. At times such as when the moving device 100 is stopped, the torque converter 1000 may be decoupled. As an example, when the device 100 is stopped, there may be no need for rimpull. However, the engine 205 is still operating and generating power. The integrated starter/generator 245 may be used to absorb the power from the spinning or idling engine 205 which may be stored as energy in a variety of the hybrid devices 200. Logically, the engine 205 speed may also be lowered to reduce wasted energy in the torque converter 1000. Thus, rimpull or power at the wheels may be reduced. As an example and not limitation, engine 205 speed may be reduced from 2,000 rpm to 1,200 rpm which may reduce rimpull around 25%. However, at the same time, the need for power may increase beyond the power of the main engine 205 operating at the lower speed. Thus, the speed of the engine 205 may need assistance to avoid to increasing power from the engine 205 which may cause unwanted rimpull. An integrated starter/generator 1000 may provide the additional power needed instead of revving the engine 205 and creating unwanted rimpull and inefficiency.

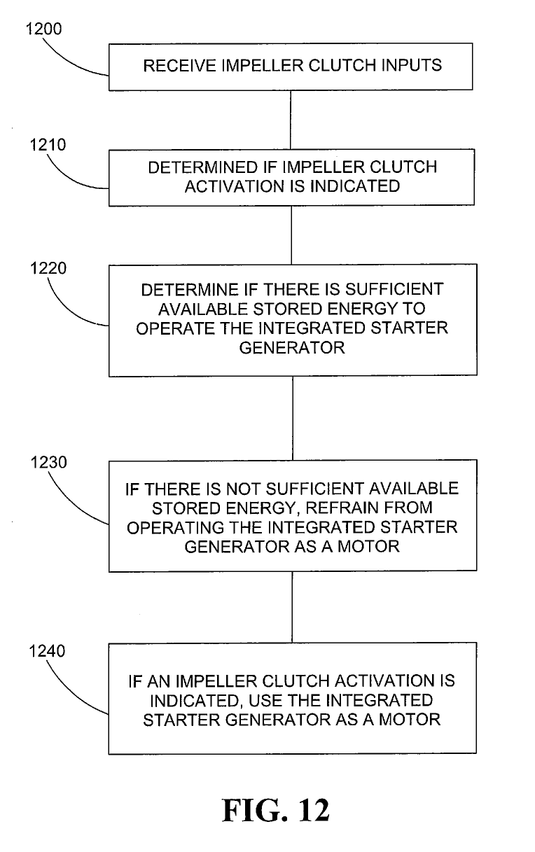

FIG. 12 may be a block diagram of steps that may be taken by a method of utilizing an integrated starter generator 245 as a hybrid power source 200 to an engine 205 in a movable device 100 to act in place of an impeller clutch to provide impeller clutch functionality without an impeller clutch. At block 1200, impeller clutch inputs may be received. The impeller clutch inputs at a high level include the current state of the device 100 and the power demand of the device 100.

At block 1210, it may be determined if impeller clutch functionality is indicated. Commonly, impeller clutch functionality activation may be based on determining if load demand for the engine 205 is greater than the power generated by the engine 205 at the current speed of the engine. Such a determination may be made mathematically such as using a lookup table to determine the available power at a certain engine speed and the power required by the device 100 for a given task.

In yet another embodiment, the engine management system may determine if the engine 205 is under undue strain. For example and not limitation, the system may note engine 205 stalling, excessive knocking or rising engine 205 temperature as indications that the engine 205 is under strain. If the engine 205 is noted as being under strain then impeller clutch functionality activation may be noted.

At 1220, if impeller clutch functionality activation is indicated, the system may determine if there is sufficient available stored energy to operate the integrated starter generator 245 to assist the main engine 205. For example, if the storage device is a battery 250 and the battery 250 is completely discharged, it does not make sense to try to activate the integrated starter/generator 245 to provide power as there will be no power in the battery 250 to turn the integrated starter/generator 245. Similarly, the amount of energy in the battery 250 may be low such that a small amount of assistance may be available. In such cases, the system may use both the main engine 205 and the limited power from the integrated starter/generator 245 before the battery 250 is drained.

At block 1230, if there is not sufficient available stored energy, the system may refrain from operating the integrated starter generator 245 as a motor. Logically, if there is insufficient power, the integrated starter/generator 245 may not be capable of providing power to the engine 205. In such a situation, it may make sense to refrain from wasting time trying the integrated starter/generator 245 and engine 205 speed may have to be increased to provide the necessary power. Of course, other hybrid systems 200 may be used to provide power if the hybrid systems 200 have sufficient stored power.

At block 1240, the integrated starter generator 245 may be used as a motor to provide additional torque to an engine 205 crankshaft. In previous systems, the primary engine 205 would be the only source of power when the power demand is increased to reduce rimpull. In the pending system, the need for additional power may be provided by continuing to allow the engine 205 speed to decrease as in a conventional system but by adding torque to the system using the integrated starter/generator 245. Thus, additional hydraulic power may be added to the system from the torque provided by the integrated starter/generator 245 without creating unwanted rimpull.

To provide the needed power, the integrated starter/generator 245 may be coupled to the engine 205 such as through the crankshaft and may provide power directly to the engine 205. The torque may be thought of as being provided to the flywheel of the engine 205. As described previously, the integrated starter/generator 245 may receive power from a power source 250 such as a battery or a capacitor. As a result, undesired power will not be delivered as rimpull but may be delivered as power where needed such as to the hybrid system 200.

As previously mentioned, the integrated starter/generator 245 may also work as a generator when excess force is available to drive the integrated starter/generator 245 as a generator. For example, if the vehicle 100 is traveling downhill, the excess force may be used to turn the integrated starter/generator 245 which may produce power which may be converted by the integrated starter/generator 245 into electricity which may be stored in a storage device 250. At the same time, turning the integrated starter/generator 245 causes the device to slow down or reduce its acceleration as some of the power is absorbed by the integrated starter/generator 245.

The system may continue to monitor the situation and respond accordingly. For example, the integrated starter/generator 245 will depower when the additional power is not needed or the engine 205 has sufficient power. As an example, if an impeller clutch activation is indicated and the integrated starter generator 245 is used as a motor to provide additional torque to an engine 205 crankshaft, the system may determine if the load has fallen below the output of the engine 205. If the load is below the output of the engine 205, the integrated starter generator 245 may be depowered from the engine 205 crankshaft.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method utilizing an integrated starter generator as a hybrid power source to an engine in a movable device comprising:
Receiving impeller clutch inputs;
Determining if impeller clutch activation is indicated;
If an impeller clutch activation is indicated, using the integrated starter generator as a motor to provide additional torque to an engine crankshaft.

2. The method of claim 1, wherein the impeller clutch activation decision is based on load demand.

3. The method of claim 1, wherein the determination of whether impeller clutch activation is indicated comprises determining if load demand for the engine is greater than power from the engine at the current speed of the engine.

4. The method of claim 1, further comprising keeping engine speed constant.

5. The method of claim 1, further comprising keeping vehicle speed constant.

6. The method of claim 1, further comprising if the device is decelerating, engaging the integrated started generator to the crankshaft as a generator to reduce crankshaft speed and generate electricity.

7. The method of claim 1, further comprising
determining if there is sufficient available stored energy to operate the integrated starter generator;
if there is not sufficient available stored energy,
refraining from operating the integrated starter generator as a motor.

8. The method of claim 7, wherein if there is not sufficient available stored energy, adding speed to the engine.

9. The method of claim 1, further comprising:
If an impeller clutch activation is indicated and the integrated starter generator is used as a motor to provide additional torque to an engine crankshaft,
determining if the load has fallen below the output of the engine; and
If the load is below the output of the engine, depowering the integrated starter generator from the engine crankshaft.

10. The method of claim 1, wherein excess power for the integrated starter/generator is stored in a battery or a capacitor.

11. A method of providing power to a work device comprising an internal combustion engine and an integrated starter generator operating as a hybrid power source to the internal combustion engine comprising:
Receiving impeller clutch inputs;
Determining if impeller clutch activation is indicated;
If an impeller clutch activation is indicated, using the integrated starter generator as a motor to provide additional torque to an engine crankshaft.

12. The method of claim 11, wherein the impeller clutch activation decision is based on load demand.

13. The method of claim 11, wherein the determination of whether impeller clutch activation is indicated comprises determining if load demand for the engine is greater than power from the engine at the current speed of the engine.

14. The method of claim 11, further comprising keeping engine speed constant.

15. The method of claim 11, further comprising keeping vehicle speed constant.

16. The method of claim 11, further comprising if the device is decelerating, engaging the integrated started generator to the crankshaft as a generator to reduce crankshaft speed and generate electricity.

17. The method of claim 11, further comprising
determining if there is sufficient available stored energy to operate the integrated starter generator;
if there is not sufficient available stored energy,
refraining from operating the integrated starter generator as a motor.

18. The method of claim 17, wherein if there is not sufficient available stored energy, adding speed to the internal combustion engine.

19. The method of claim 11, further comprising:
If an impeller clutch activation is indicated and the integrated starter generator is used as a motor to provide additional torque to an engine crankshaft,
determining if the load has fallen below the output of the engine; and
If the load is below the output of the engine, depowering the integrated starter generator from the engine crankshaft.

20. The method of claim 11, wherein excess power for the integrated starter/generator is stored in a battery or a capacitor.
